(19) United States
(12) Patent Application Publication
(10) Pub. No.: US 2008/0292075 A1
(43) Pub. Date: Nov. 27, 2008

(54) METHOD AND SYSTEM FOR QUOTING, PRICING AND ORDERING TELECOMMUNICATIONS SERVICES

(76) Inventors: Peter M. Pathos, Dallas, TX (US); George W. Poletes, Dallas, TX (US)

Correspondence Address: MICHAEL A. O'NEIL, P.C., 5949 SHERRY LANE, SUITE 820, DALLAS, TX, 75225, US

(21) Appl. No.: 12/126,029

(22) Filed: May 23, 2008

Related U.S. Application Data
(60) Provisional application No. 60/939,950, filed on May 24, 2007.

(51) Int. Cl. H04M 11/00

(52) U.S. Cl. 379/93.12

(57) ABSTRACT

A method and system for quoting, pricing, configuring, and ordering telecommunications services is disclosed. The method includes the steps of allowing a purchaser of services to custom-configure the services through an interface with several relevant service characteristics and options. A purchaser may then input service configurations into a database-driven pricing configurator that can instantly generate an indicative pricing quote for the configured services. A purchaser also has the option of submitting the quote to a service order form generator, which interfaces with a service provider's provisioning system, thereby allowing a purchaser to quote, price, and order telecommunications services in a fast, easy, and flexible manner.

### CROSS-REFERENCE TO RELATED APPLICATION

Applicants claim priority based on provisional patent application Ser. No. 60/939,950 filed May 24, 2007, the entire content of which is incorporated herein by reference.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is a schematic diagram of an online Internet bandwidth services pricing configurator according to one embodiment of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

One embodiment of the invention generally relates to a method and system for quoting and ordering networking services and in particular to a method for generating pricing quotes, service configurations, and service orders for Internet access based on a user's custom configuration.

Without limiting the scope of the invention, embodiments of the invention are described in connection with Internet access services, network access services, and other telecommunications services and is best exemplified by methods for generating pricing for, configuring, and ordering, Internet access services.

Businesses, governments, and organizations continue to rely on network communications to share and access data and communicate content in all forms. Over the last decade, the Internet has become one of the primary means for such entities of engaging in network communications.

The Internet is a collection of numerous independent networks interconnected with each other to form a network of networks. Users on different networks are able to communicate with each other through interconnection between these networks. For example, when a user of the Internet sends an e-mail to another user, assuming that each person uses a different network provider, the e-mail must pass from one network to the other in order to get to the final destination.

Monthly Internet traffic in the U.S. was projected to grow at a 34.4% Compound Annual Growth Rate from 2007 until 2008 according to the Telecommunications Industry Association. Growth in Internet traffic is being driven by increasing broadband penetration, the proliferation of bandwidth intensive services and the maturity of online business models, among other factors. Gartner projects that broadband penetration will increase from 34.3% of U.S. households in 2005 to 53.5% in 2009. Increasing broadband penetration is enabling the proliferation of bandwidth intensive services, including VoIP, online gaming, streaming video and audio, and IPTV.

Given this dramatic growth in Internet traffic, businesses of all sizes have become increasingly dependent on the Internet as a means to engage in commerce, sell products, and deliver services. Without a reliable Internet network connection, a business with an online presence can suffer devastating consequences, including lost customers, revenues, and goodwill. For examples, Boston Consulting Group found that “28% of [Internet] users do not return to a company's Web site if it does not perform sufficiently well.”

Consequently, Internet access costs have become an increasingly prominent component of the IT budgets of most businesses and organizations, especially those businesses and organizations with a “network-centric” business focus that consume Internet bandwidth at gigabit or multi-gigabit levels. Currently, a gigabit of Internet access purchased at a retail price rate from a major network service provider can cost as much as $1.2 million a year.

Even though most of the Internet is reachable from a single Internet network connection, a significant amount of businesses and IT operations “multi-home” their Internet connections by purchasing access or transit from multiple network service providers. Even if one of more network service providers fail completely, a multi-homing back-up model with two or more network carriers can allow a business to maintain Internet connectivity from a provider that is still up. As a general rule, the more network service providers with which a business multi-homes its Internet access, the more reliable its network is.

Nevertheless, businesses usually require a significant amount of time and resources to price and negotiate a typical network service agreement. Most prominent network service providers are large telecommunications companies with generally slow, non-standardized sales processes. A few large Tier 1 network service providers currently do not even publish contact information for their sales teams. More important, most network service providers do not publish current and standard pricing rates for connectivity services.

A prospective customer is therefore typically forced to engage in a protracted and time-consuming haggling process with the sales organization of a large network service provider with no certainty that it will reach an agreement on a desired price for services. Increasing this pricing uncertainty are many variables that can affect Internet access pricing, including, without limitation, the following:

duration of contract term;

caps on bandwidth usage;

delivery options and carrier backbone mix;

bandwidth commitment levels; and

size of connection port.

These factors, and others, can interact to affect pricing. Purchasers, however, are not always certain how these factors, and others, ultimately affect pricing, making bandwidth purchase a difficult and uncertain process.

As a result of this complicated and uncertain sales process, it is not unusual for a typical IT enterprise to spend upwards of 60 days negotiating a single network services contract. Many organizations are consequently forced to forego better rates on their network access services because they lack the time, resources, and personnel to engage in drawn-out contract negotiations with large network service providers. The adverse impact on an IT budget resulting from this outcome is compounded if the business wishes to multi-home with several network access providers or to renew or renegotiate existing network services agreements.

From the network service provider's perspective, this complicated and uncertain sales process can hinder sales potential, harm its goodwill and reputation, and frustrate its customers and customer prospects with a negative buying experience.

Therefore, what is needed is a method and system that allows a prospective purchaser of network services to generate pricing quotes and service orders for Internet access based on a user's custom configuration of several attributes, including without limitation, backbone carrier variety, contract term, minimum service level commitment, and the type of network connection.

One embodiment of the present invention is a system and method for configuring Internet network connectivity service to be purchased from a service provider according to service characteristics specified by the purchaser of the connection. In one embodiment, the system is comprised of an online Internet bandwidth connection pricing configurator that is one component of an Internet website.

In this embodiment, the configurator is a graphical user interface programmed in a popular website programming language such as Javascript. The configurator enables a purchaser to generate an instant price quote for Internet bandwidth connectivity services from a network services provider based on its choice of service characteristics, which, in this embodiment, include the following:

billing calculation method;

bandwidth commitment level;

connection method;

default routing protocol;

caps on outbound traffic;

length of contract term; and

breadth and choice of backbone carrier networks.

The user interface of the configurator allows a purchaser to freely modify the service characteristics in a flexible, user-friendly manner. The configurator also allows the purchaser to select from one or more service characteristic templates that a service provider can pre-configure and update from time-to-time based on specified purchaser profiles and usage patterns.

When the purchaser selects its options for all of the offered service characteristics, including data from any selected pre-configured template it may then submit the aggregate data as input into the pricing configurator. The configurator is linked to a database that is populated with data that is relevant to the set of service characteristics comprising the specific instance of the pricing configurator.

Some options selected by the purchaser may require the pricing configurator to retrieve pricing information from an external 3^{rd} party source. The pricing configurator automatically performs the pricing retrieval using a data exchange interface between itself and the external system.

Existing customers also have the option to import bandwidth usage information from their existing service and use this information to select various options to optimize their pricing quote.

The pricing configurator engine generates an indicative pricing quote for the services, as configured by the purchaser. The purchaser may also use the configurator to generate a service order form that it can directly submit to the service provider's sales department or online provisioning system.

Therefore, in accordance with the previous summary, objects, features and advantages of the present disclosure will become apparent to a person of the ordinary skill in the art from the subsequent description and the appended claims taken in conjunction with the accompanying drawing.

As used herein, the “service provider” may be an Internet service provider, backbone carrier, telecommunications company, network service provider, managed services firm, or any person or company offering or reselling networking, Internet access, bandwidth, or telecommunications services.

When describing the services offered by a service provider herein, the terms “Internet bandwidth connection services” or “services” may be used interchangeably. In further embodiments, such services can include local loop services, virtual or private networking services, transit services, or any other type of telecommunications network service.

A “purchaser” may be either an actual or prospective purchaser of the services, or any party that is considering the use or the pricing of the services. In addition, a purchaser need not be a person but may be an organization, entity, hardware device, or software application. As may be appreciated in alternative embodiments, many of the actions of the present embodiment may be accomplished by either a purchaser or the service provider.

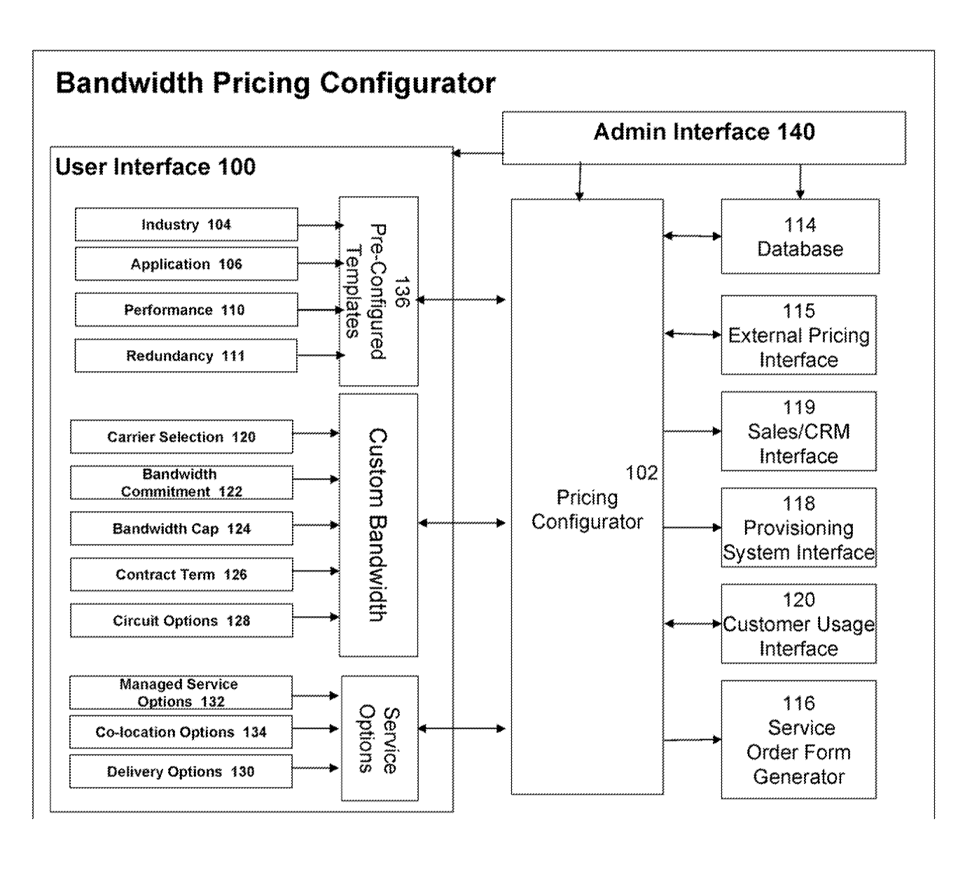

Now turning to FIG. 1, the present embodiments include an enhanced online graphical user interface 100 that enables a purchaser to custom-configure Internet bandwidth connection services by choosing among different options of service characteristic to generate a price quote and service order form for the services via the Internet.

The configurator includes a purchaser user interface 100, pricing configurator engine 102, admin interface 140, service order form generator 116, database 114, external pricing data exchange interface 115, customer usage data exchange interface 120, sales data exchange interface 119, and provisioning system interface 118.

The configurator includes a purchaser user interface 100 that allows a purchaser to input desired service characteristics and generate a quoted price for the services, as configured by the purchaser. The interface 100 may be either a graphical or a non-graphical user interface that allows a purchaser to input numerical and non-numerical values that are relevant to the selection of a given service characteristic.

As a purchaser accesses the user interface 100, it may select from a variety of service characteristics that are relevant to the purchase and pricing of Internet bandwidth services. In the preferred embodiment, these service characteristics include (a) the selection 120 of one or more carrier backbone providers offered on the service provider's network; (b) contractual bandwidth commitment level 122; (c) cap on bandwidth usage 124; (d) duration of service contract's term 126, (e) the type 128 of network port connection desired (e.g., 10, 100, or 1,000 megabit per second Ethernet port). The purchaser can also select from a variety of service delivery options 130 and managed services options 132, all of which can affect the pricing of the bandwidth service. Moreover, the configurator can also have a co-location services option. 134.

A new purchaser may also import current bandwidth usage information from its existing service via a customer usage data exchange interface 120 in order to optimize their service characteristics.

In addition, the service provider may program and customize the configurator 102 such that specific service characteristics are offered as selection options to purchasers. It may also program the pricing configurator and define the specific service characteristics based on applicable service discount levels, granularity of input choices, and types of input options.

Options selectable by the purchaser may require the price configurator 102 to request pricing information from an external system. The request is executed using an external pricing data exchange interface 115 wherein the external pricing data exchange interface 115 receives the request from the price configurator 102, reformats the request so that it is compatible with an external system, submits the request to the external system by a method required by the external system, and receives a response from the external system which is then transmitted to the pricing configurator.

The purchaser may also be given the choice of generating a pricing quote and service order form based on pre-configured templates 136. These templates consist of specific service characteristics such as but not limited to the type of industry 104, application 106, performance 110, and redundancy 111 that are pre-defined by the service provider based on a specified user profile and usage patterns. For example, the service provider could offer a template configuration for those purchasers in the computer gaming industry that desire low-latency (i.e., high performance), high-redundancy bandwidth that is tailored for real-time interactive gaming applications. In this instance, a purchaser could select an applicable template that is pre-configured by the network service provider specifically for interactive applications in the gaming industry that require high-performance bandwidth and highly redundant backbone carrier network routes.

The service provider can offer an unlimited amount of pre-configured templates for many different types of users and applications based on a fixed set of service characteristics. A purchaser can submit a given pre-configured templates into the pricing configurator, which, in turn, can generate an indicative pricing quote for the service based on the purchaser's additional input of customized service options and custom bandwidth characteristics, as described above.

When the purchaser selects its options for all of the available service characteristics, including data from any selected pre-configured template, the aggregate data is then submitted as input into the pricing configurator.

The pricing configurator 102 is linked to a database 114 that, in this embodiment, allows the service provider via the Admin interface 140 to input updated data on service discounts values for each available service characteristic, service availability, service feature availability, and other data values that are relevant to the setting of available service characteristics comprising the specific instance of the pricing configurator offered by the service provider. In the aggregate, these data and values comprise the pricing configurator engine.

In addition, the pricing configurator engine acts upon the aggregate data that is submitted by the purchaser and generates an indicative pricing quote for the services. The purchaser may continue to adjust options on the user interface 100 to re-adjust or select different input options for the service characteristics. Purchasers can save their quote for future retrieval, and the quote is sent to an external sales/CRM system via the sales/CRM data exchange interface 119. It may also submit the pricing quote to a service order form generator 116 that generates a completed service order form that is filled in with all of the service characteristic values selected by the purchaser when using the pricing configurator 102. The purchaser may then be given the option to submit the completed service order form electronically, or by hard copy, to the service provider's provisioning and sales system 118 for the completion of the order for the services.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

What is claimed is:

1. A method for quoting, pricing and ordering telecommunications services comprising the steps of:
allowing a purchaser of services to custom-configure the services through an interface with several relevant service characteristics and options;
enabling the ability of a purchaser to input service configurations into a database-driven pricing configurator that can instantly generate an indicative pricing quote for the configured services; and
allowing a purchaser to input the quote to a service order form generator, which interfaces with a service provider's sales organization or provisioning system.

2. The method of claim 1, wherein the telecommunications services are Internet bandwidth connection or access services.

3. The method of claim 1, wherein the telecommunications services are local loop or transit services.

4. The method of claim 1, wherein the telecommunications services are virtual or private networking services.

5. The method of claim 1, wherein a purchaser may utilize a pre-configured template in conjunction with custom-configuring the services.

6. A system for quoting, pricing and ordering telecommunications services comprising:
an interface for inputting service characteristics and options by a purchaser;
an admin interface for inputting data by a service provider;
a price configurator engine for calculating a pricing quote wherein the price configurator engine acts upon aggregate data comprising data supplied by a service provider via the admin interface and data inputted by a purchaser via the interface; and
a service order form generator in connection with the price configurator engine for generating a service order form manifesting the service characteristics and options selected by a purchaser.

7. The system of claim 6 further comprising a database in connection with the price configurator engine wherein the database supplies data provided by a service provider via the admin interface to the price configurator engine for generating an indicative pricing quote for services.

8. The system of claim 6 further comprising an external pricing data exchange interface in connection with the price configurator engine for requesting pricing information from an external system wherein the external pricing data exchange interface receives a request from the price configurator and transmits the request to an external system.

9. The system of claim 6 further comprising a customer usage data exchange interface for optimizing service characteristics wherein a purchaser imports data comprising existing bandwidth usage information from an existing service.

10. The system of claim 6 further comprising a sales data exchange interface for saving a quote produced by the price configurator engine for future retrieval by a purchaser.

11. The system of claim 6 further comprising a provisional system interface wherein the provisional system interface transmits a completed service order form created by the service order form generator to a sales system of a service provider for purchasing selected services offered by a service provider.

12. The system of claim 6 wherein the interface comprises pre-configured service characteristic templates customized by a service provider as a selected option for a purchaser wherein the service characteristics are pre-defined by the service provider based on a specified user profile and usage pattern.

13. The system of claim 6 wherein the purchaser is a non-human entity.

14. The system of claim 6 wherein the service characteristics comprise at least one carrier backbone provider.

15. The system of claim 6 wherein the service characteristics comprise a bandwidth commitment level.

16. The system of claim 6 wherein the service characteristics comprise a bandwidth cap.

17. The system of claim 6 wherein the service characteristics comprise a time of duration of the contract for service.

18. The system of claim 6 wherein the service characteristics comprise a type of network port connection.

19. A system for quoting, pricing and ordering telecommunications services comprising:
an interface for inputting service characteristics and options by a purchaser;
an admin interface for inputting data by a service provider;
a price configurator engine for calculating a pricing quote wherein the price configurator engine acts upon aggregate data comprising data inputted by a service provider via the admin interface and data inputted by a purchaser via the interface;
a service order form generator in connection with the price configurator engine for generating a service order form manifesting the service characteristics and options selected by a purchaser;
a database in connection with the price configurator engine wherein the database supplies data provided by a service provider via the admin interface to the price configurator engine for use in generating an indicative pricing quote for services;
an external pricing data exchange interface in connection with the price configurator engine for requesting pricing information from an external system wherein the external pricing data exchange interface receives a request from the price configurator and transmits the request to an external system;
a customer usage data exchange interface for optimizing service characteristics wherein a purchaser imports data comprising existing bandwidth usage information from an existing service;
a sales data exchange interface for saving a quoted price produced by the price configurator engine and associated service characteristics and options for future retrieval by a purchaser; and
a provisional system interface wherein the provisional system interface transmits a completed service order form created by the service order form generator to a sales system of a service provider for purchasing selected services offered by a service provider.
